(19) United States
(12) Patent Application Publication
(10) Pub. No.: US 2005/0152215 A1
(43) Pub. Date: Jul. 14, 2005

(54) Blender and sound-dampening enclosure

(76) Inventors: Jerry E. Stuart, New Hartford, CT (US); Frank R. Chiappetta, Woodbury, CT (US); Geracd A. Rutigliano, Ridgefield, CT (US)

Correspondence Address: STEVEN A. GARNER;CONAIR CORPORATION, ONE CUMMINGS POINT ROAD, STAMFORD, CT, 06902, US

(21) Appl. No.: 10/997,027

(22) Filed: Nov. 24, 2004

Related U.S. Application Data
(60) Provisional application No. 60/524,818, filed on Nov. 25, 2003.

(51) Int. Cl. A47J 43/046

(52) U.S. Cl. 366/205; 366/206

(57) ABSTRACT

A blender has novel sound-dampening enclosure system that is selectively and conveniently attached to and detached from a blender, or retro-fitted to a blender, utilizing a bottom wall portion for engaging a blender jar base in a fixed manner. Another aspect of the blender includes a simplified control logic using a minimal number of input buttons and using user-prompts.

### CROSS-REFERENCE TO RELATED APPLICATIONS

None.

### BACKGROUND OF THE INVENTION

1. Field of the Invention

The present invention relates to food and beverage blenders and, more particularly to a multiple-feature blender having a sound enclosure that is adapted to be installed to or removed selectively from, or to retro-fit, existing blenders; and to a blender operating system that includes novel operational sequences and programming capabilities.

2. Description of Related Art

Various food and beverage blenders for home or commercial use typically include a base that houses an electric motor and drive assembly including blades that rotate at very high rates in order to chop, mix or blend food or beverage ingredients contained in a jar attached to the base. The noise generated by the blender while it is operating is often substantial and can be irritating to people in close proximity to the blender. This problem is significant to a home user as well as in a commercial establishment where customers are subject to the sounds of the surrounding environment.

At least one known blender design incorporates a sound-dampening enclosure. The enclosure incorporates a three-dimensional, generally rectangular box that surrounds and encloses a blender jar mounted to a base. The enclosure is opened or closed by lifting a movable section of it that is hinged to the remaining portion. The sound enclosure is designed to exclusively fit the particular base and is, thus, dedicated to a particular model. Due to its mounting design, the enclosure cannot be conveniently or quickly attached or detached to or from the base.

Other known aspects of blenders include variable speed controls, countdown timers, pre-set programs, user-defined programs, automatic start and stop, and user-input controls. For instance, known blenders provide pre-programmed selections for running a blender at a specific speed for a predetermined time. Certain known blenders enable a user to modify such pre-set programs using push-button inputs. Among such blenders are a variety of control panels that include touchpads, buttons, knobs and LED or LCD displays. By adding various controls and functions, the complexity of operation, programming and use sometimes requires that a user refer to a manual during operation. In addition, numerous buttons and controls on a control panel take up large amounts of space.

### OBJECTS AND SUMMARY OF THE INVENTION

It is desirable to provide a blender that overcomes the shortcomings of known devices and, thus, it is an object of the present invention to provide a blender having a sound-dampening enclosure that is adapted to be retro-fitted to existing blenders of varying sizes that do not have originally existing sound-dampening enclosures, and that is easily attached or detached from a blender for use either with or without the sound-dampening enclosure, and that provides superior sound dampening, and that has a low exterior profile. It is also an object of the present invention to provide a multi-function, programmable blender that has logic controls, and input and output means, that prompts a user in a manner sufficient to eliminate the need for a user manual and that requires little control panel space. These are other objects are achieved by the present invention described herein.

The present invention is directed to a blender having novel control logic and input and output means, and to a blender sound-dampening enclosure system that is selectively and conveniently attached to and detached from a blender.

In a preferred embodiment of the present invention, the sound-dampening enclosure comprises two parts. The first part has three sidewalls, a partial top wall, and a partial bottom wall. The partial bottom wall is a flange-like projection that extends from and along the length of all three side walls and that has a relatively narrow width so that it forms a square-cornered “C” shape. The partial bottom wall, being of a general “C” shape, is adapted to be placed on top of a blender jar base while enclosing from three sides the central portion of the jar base where the blending blade and spindle project. The first part is held to the jar base by one or both of screws or fasteners directly attached to the partial bottom wall, and by positioning the partial bottom wall underneath a portion of the blender assembly such as a jar-pad, which is commonly a rubber pad that sits on top of the blender jar base and beneath ajar that is attached to the base. The second part of the sound-dampening enclosure is shaped similarly to the first part but without the partial bottom wall, and is hingedly connected to the first part and adapted to be swung between an opened and closed position.

Another aspect of the preferred embodiment of the present invention is directed to a control system having an electronic display and one or more up/down arrow buttons for scrolling to various selections after being prompted by a visual indication on the screen. By using an electronic display and buttons in combination to communicate numerous prompts and inputs, a relatively large number of operations commands and programming steps can be performed with a relatively small and uncomplicated control panel.

### BRIEF DESCRIPTION OF THE DRAWINGS

FIG. 1 is a perspective view of a preferred embodiment sound-dampening enclosure according to the present invention, shown in an opened position.

FIG. 2 is a perspective view of the sound-dampening enclosure according to the present invention, shown in a closed position.

FIG. 3 is a bottom view of the sound-dampening enclosure according to the present invention, shown in a closed position.

FIG. 4 is a top, exploded view of the sound-dampening enclosure according to the present invention.

FIGS. 5, 6 and 7A are—respectively—front, side and perspective views of the sound-dampening enclosure according to the present invention shown assembled to a blender base and in a closed position.

FIG. 7B is an exploded view according to FIG. 7A.

FIGS. 8A-8C are—respectively—front, rear and perspective views of a blender jar assembled to a blender base according to the present invention.

FIG. 9 is a schematic view of a first embodiment control panel according to the present invention.

FIG. 10 is a schematic view of a second embodiment control panel according to the present invention.

FIG. 11 is a schematic view of a third embodiment control panel according to the present invention.

FIG. 12 is a flow diagram illustrating operational sequences according to a preferred embodiment of the present invention.

FIG. 13 is a schematic view of a fourth embodiment control panel according to the present invention.

### DETAILED DESCRIPTION OF THE INVENTION

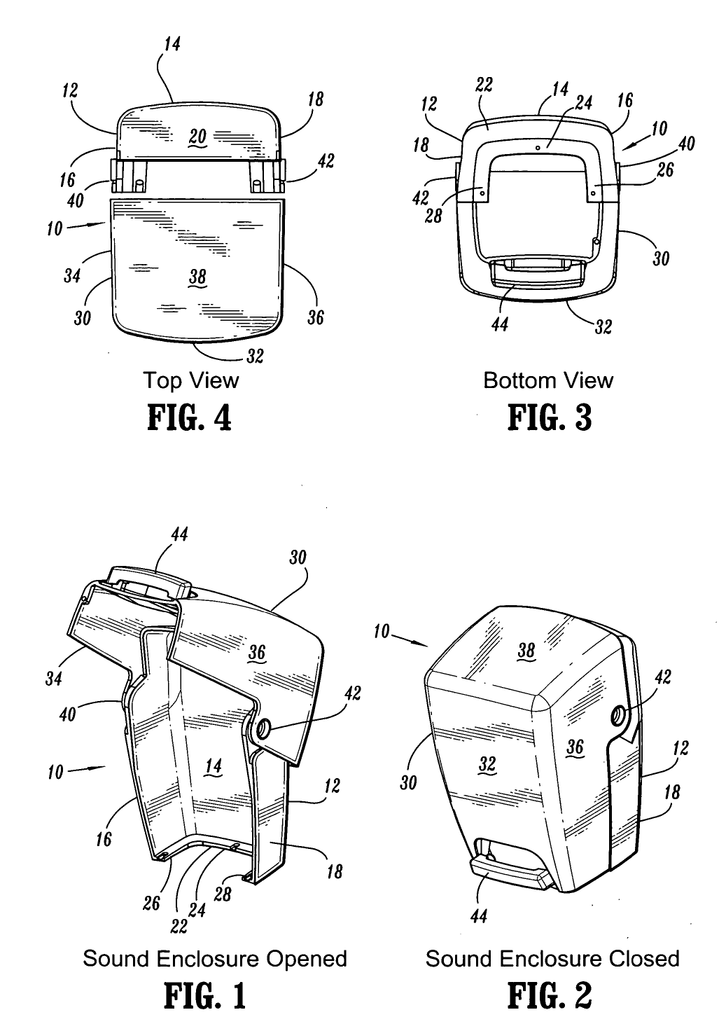

A first embodiment of the present invention is directed to the sound-dampening enclosure shown in FIGS. 1-4. The enclosure (10) comprises a first portion (12) having a rear wall (14), two side walls (16, 18), a top wall (20), and a bottom wall (22). The bottom wall (22) is made of three sections: a rear section (24), and two side sections (26, 28). The rear section (24) extends from the rear wall (14) in a bottom wall plane. The two side sections (26, 28) extend from the side walls (16, 18), respectively, in the same plane, so that the bottom wall (22) generally forms a “C” shaped section in the bottom view of FIG. 3. The enclosure (10) further comprises a second portion (30) having a front wall (32), two side walls (34, 36), and a top wall (38). The first and second portions (12, 30) are pivotally connected to each other by hinge connections (40, 42) on respective sides of the enclosure (10). The hinge connections (40, 42) may be of any one of a variety of types that may be molded directly into the respective side walls (16, 18, 34, 36) that mate, or that may be pinned using separate hinge components. A handle (44) may be molded directly into the front wall (32) of the second portion (30), or a separately constructed handle may be attached.

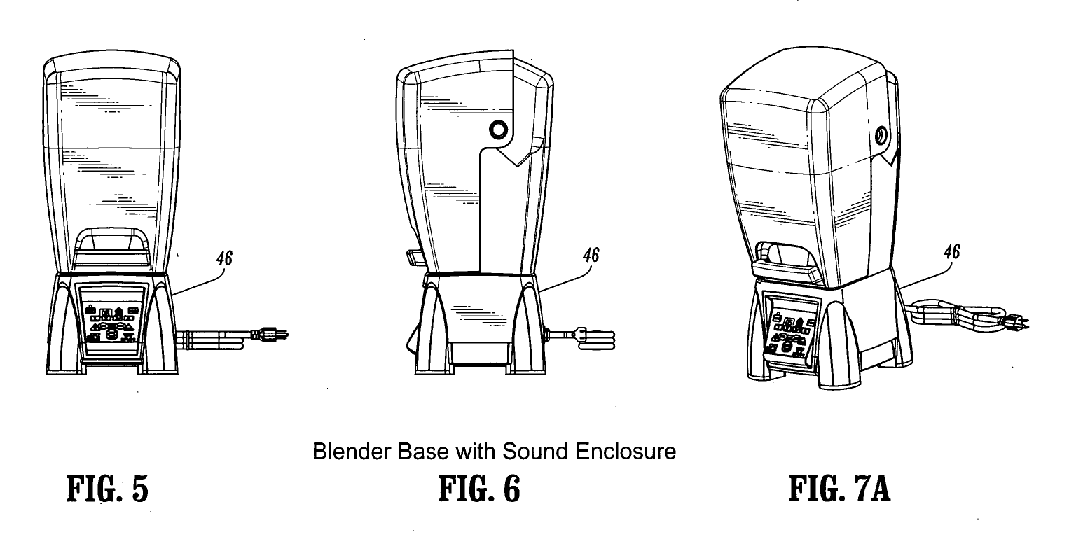

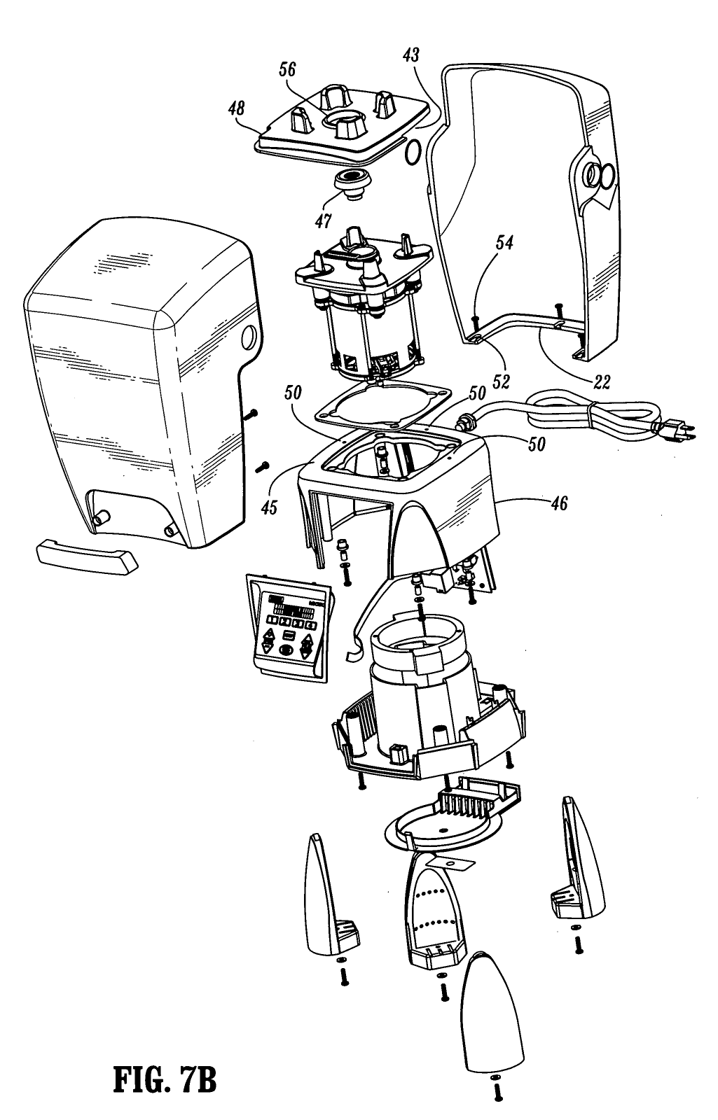

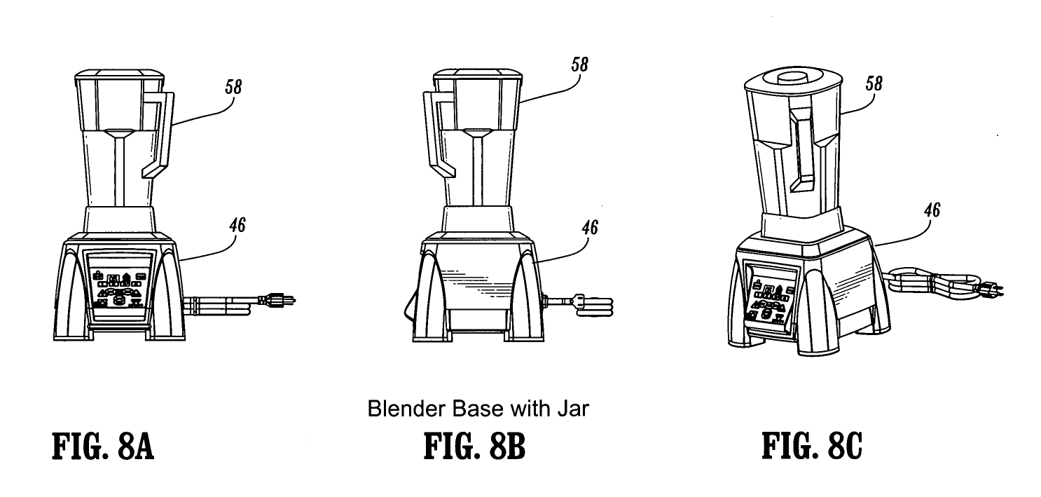

In use, the enclosure (10) is mounted to a blender base (46) as shown in FIGS. 5-7A. Referring to FIG. 7B, the bottom wall (22) of the first portion (12) is, preferably, positioned underneath ajar-pad (48) on the blender base (46). Because the bottom wall (22) is of a generally “C” shaped section, it does not interfere with a spindle (47) and blender blade (not shown) that protrude from the center of the base (46). The jar-pad (48) is preferably a pad made of rubber that rests upon the blender base (46) top surface (45) and provides a secure, resilient seat for a blender jar (58), such as that shown in FIGS. 8A-8C. A cut-away portion (43) of the pad (48) accommodates the presence of the bottom wall (22) of the enclosure (10). For illustrative purposes, the views of FIG. 8A-8C are shown without the enclosure (10) mounted on the base (46). In use, the enclosure (10) is mounted to the base (46), as shown in FIGS. 5-7A, in a manner in which it surrounds and encloses a blender jar (58). A central hole (56) in the pad (48) facilitates a spindle a rotating blender blade. The blender base (46) and bottom wall (22) may be provided with cooperating screw holes (50, 52) that can be lined up and fastened with screws (54) underneath the jar pad (48). After fastening the screws (54), the jar-pad (48) can be positioned over the bottom wall (22). The two portions (12, 30) may be constructed of any suitable material that provides sufficient structural integrity to support itself and hold up to repetitive opening and closing, and that provides sound insulation. In the preferred embodiment, the two portions (12, 30) of the enclosure (10) are made of transparent molded plastic.

When the enclosure (10) is mounted to a blender base (46) as shown in FIGS. 5-7A, the enclosure may be selectively opened and closed between the positions shown in FIG. 1 and FIG. 2, respectively, to access the space inside for installing and removing a blender jar (58). When the enclosure (10) is closed, it dampens noise created by the blender blade moving relative to food or other ingredients being blended.

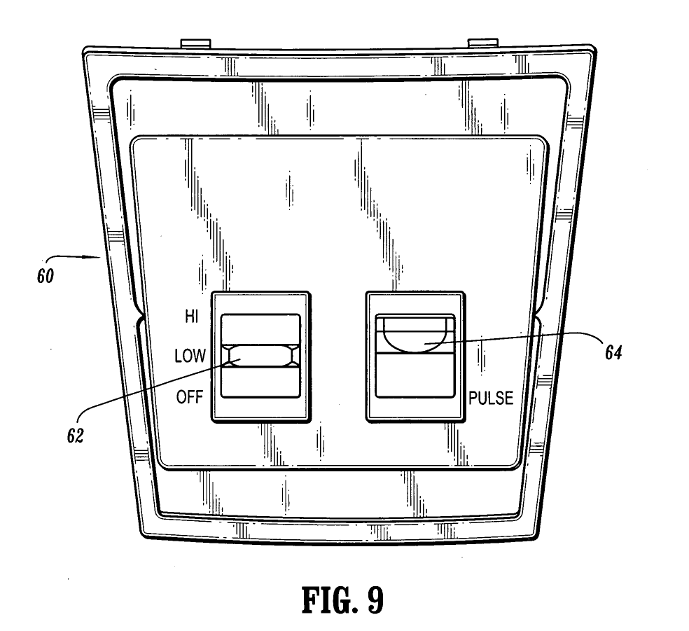

Another aspect of the preferred embodiment relates to the function and control input/output system. In a first embodiment, schematically illustrated in FIG. 9, a control panel (60) on the front of the blender base (46) has a first paddle switch (62) and a second paddle switch (64). The first paddle switch (62) is movable between three positions: “hi”; “low”; and “off”, respectively. The first paddle switch (62) is connected through conventional logic circuitry to control the speed of a conventional blender motor that drives blender blades positioned through the bottom of the jar (58). The “hi” and “low” modes of operation denoted by the first switch (62) refer to relatively high and low rotational speeds of the motor driven blender blade. The second switch (64) is movable between two positions: “pulse”; and “off”. The pulse position will cause the blender blade to rotate while the second switch (64) is held in the pulse position if the first switch (62) is in the off position. The switch (64) is a spring-biased momentary contact switch that is biased toward the off position so that, if released, the switch (64) will revert back to the off position. If the second switch (64) is moved to the pulse position while the first switch (62) is in the low position, the blender blade speed will increase and maintain an increased speed as long as the second switch (64) is held in the pulse position. If the second switch (64) is released while the first switch (62) is in the low position, the speed resumes to the condition prior to activating pulse. Operation is stopped if the first switch (62) is positioned to the off position.

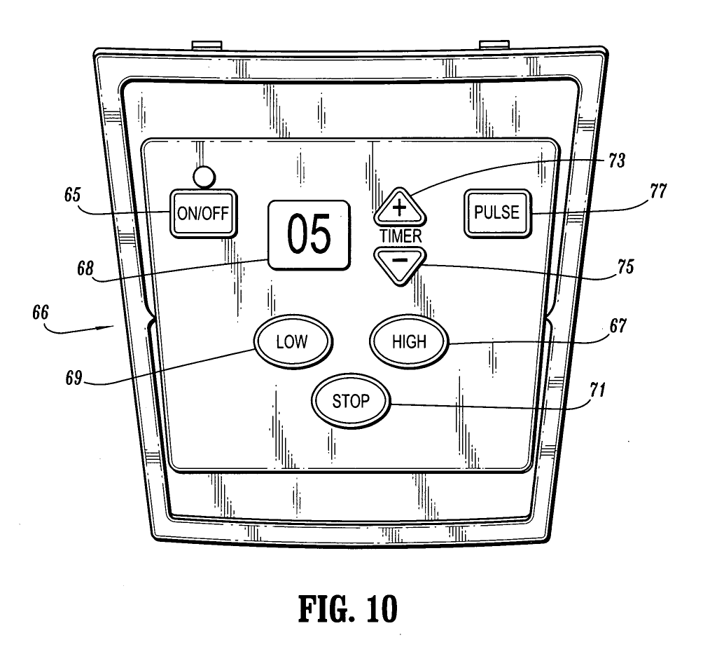

In another embodiment, shown in FIG. 10, a control panel (66) has touchpad buttons: “on/off” to turn power on to the blender; “high” “low” and “stop” to run blender speeds, respectively, at a relatively high rotational speed, a relatively low rotational speed, or no speed; “timer” (73) “+” and “−” (75) to program a run time upon which, at expiration of a selected time, the blending operation will automatically stop; and “pulse” (77) which, when pressed and held, operates the blender if it is an at rest condition, or speeds up the blender if it is already operating at low speed. The control panel (66) also includes a display screen (68) that displays the run-time remaining if the “timer” feature is activated. The display screen (68) is preferably an LED, but may also be an LCD.

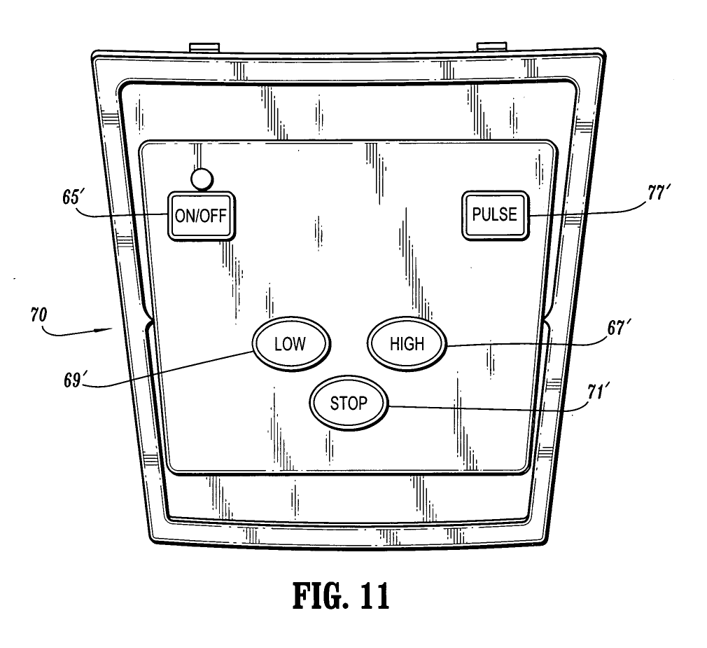

Yet another control panel embodiment is shown in FIG. 11, where a control panel (70) has touchpad buttons that operate and are arranged essentially the same as the embodiment of FIG. 10, and hence like reference numerals are indicated in the illustration, but does not include the timer function, and its associated input buttons or display screen.

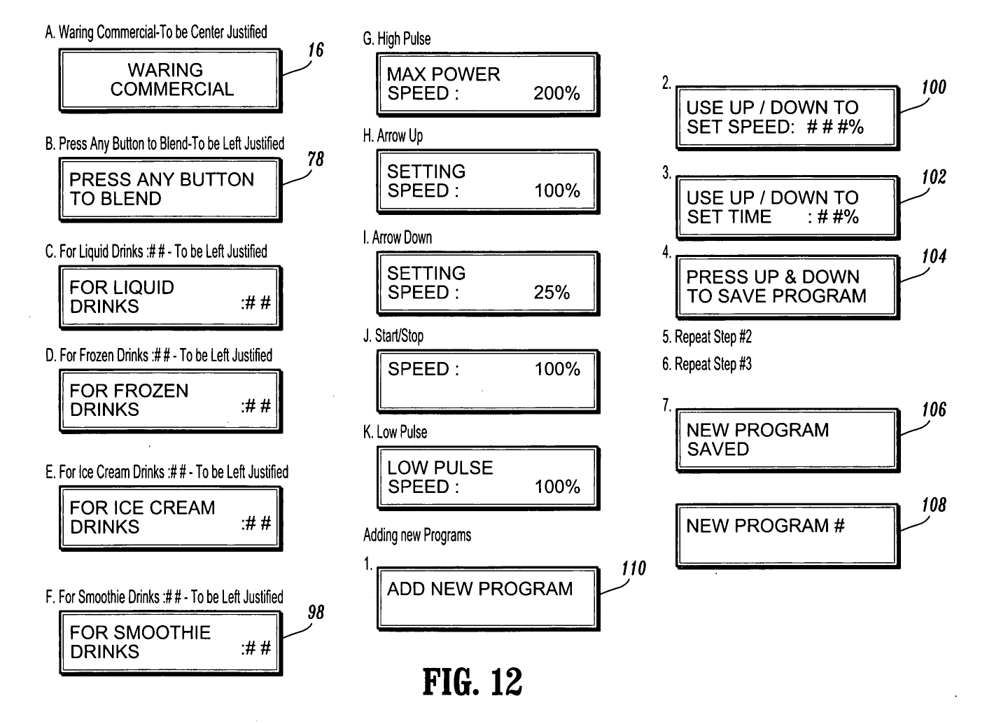

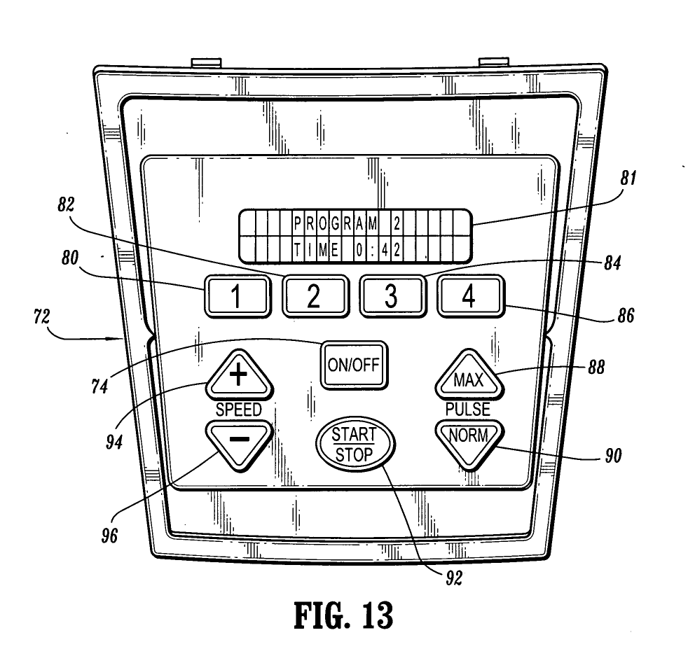

Another embodiment of the present invention relates to an interactive screen display with user prompts for various functions. Referring to the schematic of the control panel (72) shown in FIG. 13 and the flow-chart diagram of FIG. 12, when the blender is initially powered up using the “on/off” button (74), a first message (76) greets the user with, for example, the blender manufacturer name. After a specified time-out period, the greeting is replaced with a prompt (78) on the display screen (81) stating “PRESS ANY BUTTON TO BLEND”. The button choices are from among four pre-programmed sequences (80, 82, 84, 86), maximum pulse (88), or normal pulse (90). The user then presses any button to bring up the next display prompt, “FOR LIQUID DRINKS: ##”, where “##” is representative of a particular number that the user enters using either numerical buttons (80, 82, 84, 86) or, alternatively, a scrolling button (not shown) to select the proper number to make this selection. If this selection is not desired, the user presses another button, which may be pre-programmed from among one of the present buttons, to advance the display to the next message: “FOR FROZEN DRINKS: ##”. In a similar manner, the user may select this selection or move on to successive prompts that include: “FOR ICE CREAM DRINKS: ##”; and “FOR SMOOTHIE DRINKS: ##”. For each of the selections, the numerical code “##” assigned to a selection is indicative of a particular blender speed setting suitable for the type of blending operation indicated in the descriptive prompt. The user makes a selection from one of the foregoing choices and the blender will operate at the respective speed. If desired, the blender may be programmed to run for a specified duration corresponding to one of the selections in addition to a specified blender speed. Alternatively, either one of speed or duration can be set constant for all of the selections, with the other varying according to the user input selection.

When the pulse button (88) is activated, it speeds up the blender blade rotation rate to 150% that of the normal high setting. Correspondingly, the display screen (81) will read “MAX POWER SPEED: 150%”. If desired, instead of using on of the pre-set selections referred to in the preceding paragraph, a user may simply activate the start/stop button (92) to cause the blender blade to rotate. The display screen will read “SPEED: 100%” to indicate that the blender blade is rotating at full speed. If the user desires to change the “SPEED+” or “SPEED−” buttons (94, 96) buttons are used to scroll up or down and the display screen (81) will display a percentage of the original speed indicative of the speed relative to full speed (e.g., “80%”, “50%” etc.).

Preferably, if the “SMOOTHIE DRINKS” option (98) is selected from one of the pre-set buttons (86, for example) the user is prompted (100, 102) to sequentially set speed and time using, for example, the arrow keys (94, 96), and then prompted to save the settings (104). An indication of a saved program (106) followed by a confirmation (108) enables users to create and store new programs. The blender may be provided with pre-installed programs such as, for example, a set time and speed of operation. If a user wishes to replace any one of the programs with a custom program, the user scrolls on the display screen (81) to a display that reads: “ADD NEW PROGRAM” (110). The display then reads: “USE UP/DOWN TO SET TIME: ##” (102), prompting the user to use up/down buttons to scroll to a numerical entry indicative of time that will display in the digits “##” . The user is then prompted to save the program (104) by pressing a button such as an up/down button. A message will read: “NEW PROGRAM SAVED” (106) and it will indicated which program number or address is assigned to the new program so that the user may call it up and activate it by name.

While the preferred embodiment has been herein shown and described, it is understood that modification can be made without departing from the scope of the claimed invention.

1. An enclosure for an appliance comprising:
a first section;
a second section;
a hinge for connecting said first section to said second section wherein said second section is adapted to selectively pivot relative to said first section about said hinge; and
a fastener adapted to selectively secure said first section to said appliance.

2. An enclosure according to claim 1, further comprising
a base-engaging section on said first section adapted to engage an appliance base and support said enclosure thereon.

3. An enclosure according to claim 2, wherein
said base-engaging section comprises a generally flat portion adapted to rest on said base.

4. An enclosure according to claim 3, wherein
said generally flat portion is received between said base and a flexible base cover.

5. An enclosure according to claim 3, wherein
said generally flat portion forms a generally “C-shaped” flange.

6. An enclosure according to claim 2, wherein
said base-engaging section comprises fastener holes adapted to receive fasteners therethrough for attaching said enclosure to said base.

7. A blender comprising:
a base;
a blade for processing food;
ajar above said base adapted to hold said food to be processed;
a motor within said base for driving said blade;
a control panel comprising:
a first switch having a first position at which said blade remains stationary, a second position for rotating said blade at a first speed and a third position for rotating said blade at a second speed that is faster than said first speed; and
a second switch adapted to be depressed to increase the speed of said blade for the duration of time that said switch is depressed;
and
an enclosure for said blender comprising:
a first section;
a second section;
a hinge for connecting said first section to said second section wherein said second section is adapted to selectively pivot relative to said first section about said hinge; and
a fastener adapted to selectively secure said first section to said blender.

8. A blender according to claim 7, further comprising
a base-engaging section on said first section adapted to engage an appliance base and support said enclosure thereon.

9. A blender according to claim 8, wherein
said base-engaging section comprises a generally flat portion adapted to rest on said base.

10. A blender according to claim 9, wherein
said generally flat portion is received between said base and a flexible base cover.

11. A blender according to claim 9, wherein
said generally flat portion forms a generally “C-shaped” flange.

12. A blender according to claim 8, wherein
said base-engaging section comprises fastener holes adapted to receive fasteners therethrough for attaching said enclosure to said base.

13. A blender according to claim 7, wherein
said second switch is adapted to be depressed to rotate said blade at said first speed when said first switch is in said first position and at said second speed when said first switch is in said second position.

14. A blender according to claim 7, wherein
said second switch further comprises a spring adapted to bias said second switch away from said depressed state.

15. A blender comprising:
a base;
a blade for processing food;
ajar above said base adapted to hold said food to be processed;
a motor within said base for driving said blade;
a control panel, said control panel comprising:
a first button for providing or shutting power to said blender;
a plurality of secondary buttons for controlling the rotating speed of said blade; and
a pulse button adapted to increase the speed of said blade for the duration of time that said button is depressed;
and
an enclosure for said blender comprising:
a first section;
a second section;
a hinge for connecting said first section to said second section wherein said second section is adapted to selectively pivot relative to said first section about said hinge; and
a fastener adapted to selectively secure said first section to said blender.

16. A blender according to claim 15, further comprising
a base-engaging section on said first section adapted to engage an appliance base and support said enclosure thereon.

17. A blender according to claim 16, wherein
said base-engaging section comprises a generally flat portion adapted to rest on said base.

18. A blender according to claim 17, wherein
said generally flat portion is received between said base and a flexible base cover.

19. A blender according to claim 17, wherein
said generally flat portion forms a generally “C-shaped” flange.

20. A blender according to claim 16, wherein
said base-engaging section comprises fastener holes adapted to receive fasteners therethrough for attaching said enclosure to said base.

21. A blender according to claim 15, wherein
said control panel further comprises a plurality of timer buttons adapted to program a duration of time that said blade rotates.

22. A blender according to claim 21, wherein
said control panel further comprises a display screen for displaying the amount of time remaining.

23. A blender according to claim 22, wherein
said display screen is an LED.

24. A blender according to claim 22, wherein
said display screen is an LCD.

25. A blender according to claim 15, wherein
said control panel further comprises a plurality of program buttons adapted to rotate said blade at a preprogrammed speed.

26. A blender according to claim 25, wherein
said plurality of program buttons are adapted to rotate said blade at said preprogrammed speed for a preprogrammed duration of time.

27. A blender according to claim 15, further comprising
a display screen for displaying information about the operation of said blender.

28. A blender according to claim 27, wherein
said display screen is an LED.

29. A blender according to claim 27, wherein
said display screen is an LCD.
